(19) United States
(12) Patent Application Publication
(10) Pub. No.: US 2007/0110946 A1
(43) Pub. Date: May 17, 2007

(54) Optical storage medium

(75) Inventor: Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/555,842

(22) PCT Filed: Apr. 29, 2004
(86) PCT No.: PCT/IB04/50551

§ 371 Date: Nov. 3, 2005

(30) Foreign Application Priority Data
May 8, 2003 (EP) 03101277.6

(51) Int. Cl. B32B 3/02

(52) U.S. Cl. 428/64.4

(57) ABSTRACT

An optical storage medium comprising a storage layer (4) and a first layer (5) covering the storage layer (4). The first layer (5) provides optical properties sufficient for data retrieval from the storage layer using a laser (8) with a first wavelength W₁. A second layer covers the first layer (5) and provides optical properties sufficient for data retrieval from the storage layer using a laser with a second wavelength W2.

The present invention relates to an optical storage medium.

Optical recording media are commonly used as memory devices in computers and consumer electronic products. Since the introduction of the Compact Disc (CD) further optical recording media such as the digital video disc (DVD) and the Blu-ray Disc (BD) have been developed in order to enhance the storage capacity of the media The increase in data capacity is usually done by scaling down the size of the information bits (represented by pits or marks) in the disc. This is achieved by increasing the numerical aperture (NA) of the objective lens and decreasing the wavelength of the read/write laser beam. A laser beam focused in a small spot scans the data layer of the media in order to read out the information stored in the optical recording medium. CDs are scanned by a laser, which has a wavelength of 780 nm and focused by a lens with a numerical aperture (NA) of 0.45. DVDs require a laser with a wavelength of 650-670 nm and a lense with NA=0.65 and BD is scanned with a laser having a wavelength of 405 nm and focused by a lense with NA=0.85.

The success of a new optical storage system largely depends on compatibility with the older systems. Consumers expect to be able to use recording media with older format such as the CD in newer storage devices such as the DVD player. One of the major issues there is the compatibility of the media with the requirements of the drives. Usually it is impossible to read-out the newer (higher capacity) format media (such as e.g. DVD media) with the older (e.g. CD) drives since the CD laser spot is much bigger than that of DVD and it covers several data tracks and many data pits/marks at the same time. By contrast, it is possible (at lease theoretically) to trace single data tracks of the older type media on the newer type drives. However, it is often the case that optical characteristics (such as reflection level and signal modulation) of the older media at the laser wavelength of the newer system do not correspond to the requirements of the newer system. For this reason DVD-drives capable of reading CDs use two different wavelengths for reading. The first wavelength is the CD wavelength of 780 nm and the second wavelength is the DVD wavelength of 670 nm. These DVD-drives need two different laser diodes for generating the different wavelengths and means for discerning DVDs from CDs. As a result, the DVD-drives are more expensive and complex. The same principal is expected to be implemented in BD-drives capable of reading DVDs.

The object of the invention is to overcome the previously mentioned drawback.

The problem is solved by an optical storage medium according to independent claim 1. The optical storage medium has a storage layer and a first layer, which preferably covers the storage layer. The first layer provides optical properties sufficient for data retrieval from the storage layer using a laser with a first wavelength W₁. Hence data may be read from the storage laser by using a laser with the first wavelength W₁. The laser beam is transmitted through the first layer onto the storage layer and reflected thereof. Information is usually recorded onto the optical storage medium using the laser with the first wavelength W₁. In accordance with the present invention disclosure, the optical storage medium further comprises a second layer, which preferably covers the first layer. The second layer provides optical properties sufficient for data retrieval from the storage layer using the laser with the second wavelength W₂ without deteriorating the optical properties of the medium at the first wavelength W₁. Consequently data may be retrieved from the storage medium using two different wavelengths W₁ and W₂. The storage medium is compatible with different optical storage systems as far as the optical properties are concerned.

Preferably the refraction index N_{L1}(W₁) of the first layer for the first wavelength and the refraction index N_{L2}(W₁) of the second layer for the first wavelength are chosen in such a way that the relative difference between the refraction indexes (N_{L1}(W₁)−N_{L2}(W₁))/N_{L1}(W₁) does not exceed 0.1. The purpose of this measure is to avoid, that a laser beam with the first wavelength is refracted by the second layer in such a way, that data may not be read out of the storage layer.

The first layer may provide optical properties sufficient for data retrieval from the storage layer using a laser beam with a first wavelength W₁ of 670 nm (DVD) and the second layer provides optical properties sufficient for data retrieval from the storage layers there using a laser beam with the second wavelength W₂ of 405 nm (BD). This optical storage medium may be used in both DVD-drives and BD-drives. It has been found that the best optical properties are aclijeved, if the second layer is made of 2-Ethylen-2-cyano-4-(3-methyl-2-oxazolinylidene)-crotonate (C₁₇H₂₆N₂O₃). The thickness of the second layer lies preferably within the range of 60-70 nm.

The preferred embodiment of the present invention is described herein with reference to the accompanied drawings.

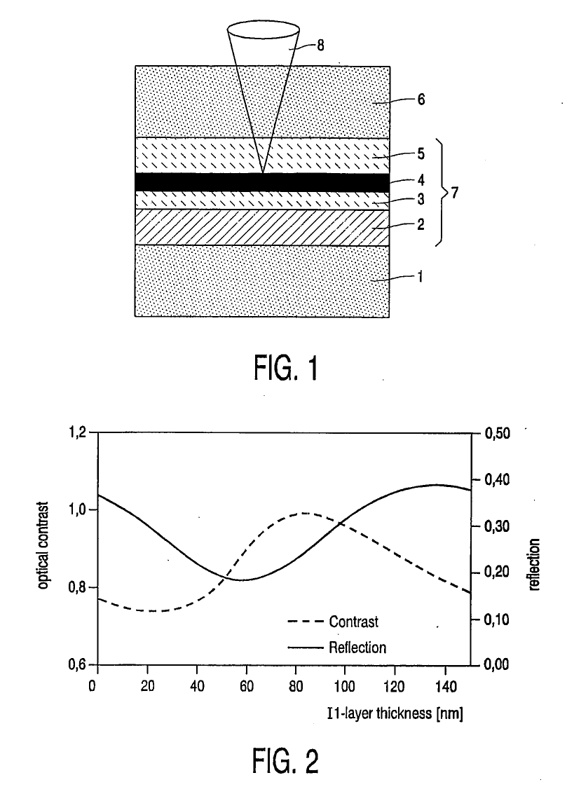

FIG. 1 shows a cross-section of a conventional DVD storage medium.

FIG. 2. shows a graph representing the optical contrast and the reflection level of the conventional DVD of FIG. 1 as a function of the thickness of the first layer L1 for a laser beam with a wavelength of 670 nm.

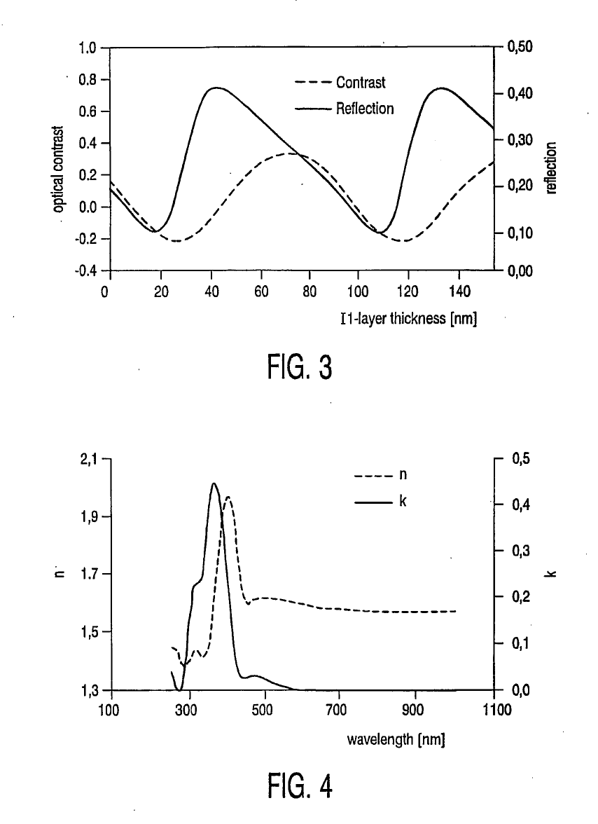

FIG. 3 shows a graph representing the optical contrast and reflection level of the conventional DVD optical recording medium of FIG. 1 as a function of the thickness of the first layer L1, when a laser beam having a wavelength of 405 nm is used.

FIG. 4 shows a graph representing the refraction index and absorption coefficient of the material C₁₇H₂₆N₂O₃ employed in the preferred embodiment as a second layer L2 as a function of the wavelength of a laser beam.

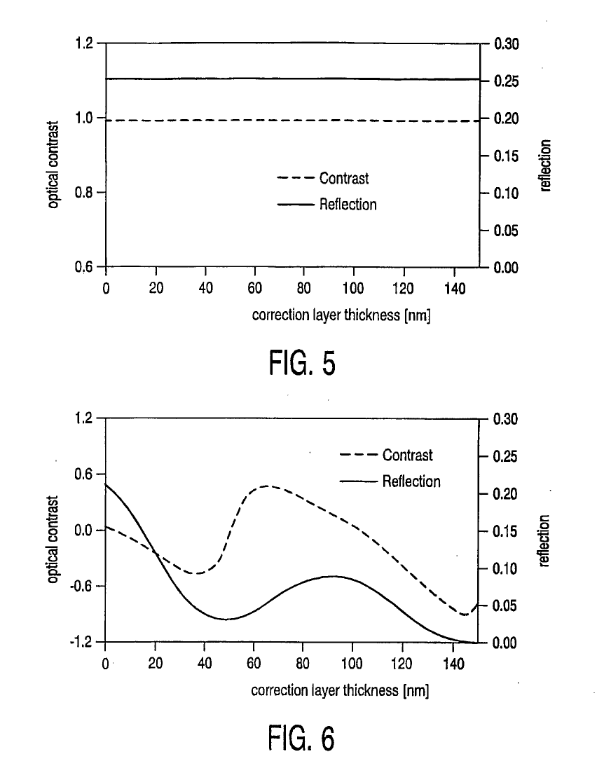

FIG. 5 shows a graph representing the optical contrast and reflection level of the recording medium according to the preferred embodiment as a function of the thickness of the correction layer L2, if a laser beam with a wavelength of 670 nm is employed.

FIG. 6 shows a graph representing the optical contrast and the reflection index of the optical recording medium according to the preferred embodiment for a monochromatic laser beam with a wavelength of 405 nm as function of the thickness of the second layer (correction layer) L2.

The DVD medium shown in FIG. 1 comprises a dummy substrate 1 which is made out of polycarbonate. The dummy substrate has a thickness of roughly 0.6 mm. A reflector layer 2 is provided on top of the dummy substrate 1. The reflector layer consists of a silver alloy. The thickness of the reflector layer equals roughly 120 nm. A dielectric layer 3 with a thickness of 25 nm is provided on top of the reflector layer and is made out of ZnS:SiO₂. The dielectric layer is transparent for laser beams with a wavelength of 670 nm and 405 nm. The recording layer 4 is provided on top of the dielectric layer 3. The recording layer has a thickness of 15 nm and is made out of a doped Sb—Te alloy. The material of the recording layer is either amorphous or crystalline. The amorphous and crystalline regions of the recording layer represent the information bits encoded in the layer. The different optical properties of amorphous and crystalline recording layer may be detected by the reflection of the laser beam 8 which is scanned across this layer 4. The optical contrast is defined as the difference between the radiation reflected from the amorphous and crystalline regions of the recording layer divided by the radiation reflected from the crystalline region of the recording layer. The reflection level is the ratio between the radiation reflected from the crystalline recording layer and the radiation input. The laser radiation 8 passes through a first layer 5 and a substrate 6 provided consecutively on top of the recording layer 4. The layers 2, 3, 4 and 5 form the recording stack 7 of the recording medium. The first layer L1 is also made out of ZnS:SiO₂ and has a thickness of approximately 85 nm.

FIG. 2 shows how the optical contrast and reflection level of the known DVD recording medium changes, if the thickness of the first layer 5 is increased or reduced. The maximum optical contrast of the recording medium is reached at a layer thickness of 85 nm. At this point, the optical contrast is equal to 0.999 (or 99.9 percent) and the reflection level is equal to 0.256 (or 25.6 percent), respectively. The reflection level reaches a minimum at around 60 nm layer thickness. The optical contrast and reflection of the DVD medium is determined in FIG. 1 for a laser beam with the wavelength of 670 nm.

In FIG. 3 the optical contrast and reflection of the known DVD recording medium is shown once again. This time a laser beam with a wavelength of 405 nm was used to detect the optical contrast and reflection level. The optical contrast has a maximum at approximately 75 nm layer thickness and minima at 25 nm and at 115 nm layer thickness. The reflexion level has two maxima at 40 nm and 130 nm layer thickness. The optical contrast is equal to 0.223 (or 22.3 percent) for a layer thickness of 85 nm. The reflection level is equal to 0.242 (or 24.2 percent) at the same layer thickness. The optical contrast is not sufficient for reading out the data recorded on the recording layer.

The preferred embodiment of the present invention comprises all the layers of the known recording medium shown in FIG. 1. Additionally, a second layer L2 is introduced between the first layer 5 and the substrate 6. The second layer L2 is made out of C₁₇H₂₆N₂O₃. The index of refraction and the absorption coefficient of this material for different wavelengths is shown in FIG. 4. The absorption coefficient k for the material has a maximum at a wavelength of around 380 nm. The index of refraction n for the material has a maximum at a wavelength of approximately 420 nm. The material has an index of refraction n of about 1.589 for a wavelength of 670 nm. The absorption coefficient k is equal to 0.000 for the wavelength of 670 nm.

The insertion of the second layer L2 improves the optical contrast of the recording medium for a wavelength of 405 nm considerably without negatively affecting the optical contrast for the wavelength of 670 nm. This is depicted in FIGS. 5 and 6.

FIG. 5 shows the influence of the second layer (correction layer) on the optical contrast and reflection index of the recording medium. The values are detected for the DVD wavelength of 670 nm. The optical contrast of 0.99 (or 99 percent) is not affected for layer thicknesses in the range of 0 to 150 nm. The reflection index of 0.256 is also unaffected.

FIG. 6 shows the optical contrast and reflection level of the recording medium according to the preferred embodiment for laser beams with a wavelength of 405 nm. The optical contrast at this wavelength has a peak if the thickness of the correction layer is chosen to be 66 nm. The reflection level has a maximum at a layer thickness of approximately 95 nm. The recorded value of the optical contrast is equal to 0.692 (or 69.2 percent). This is a considerable improvement in comparison with the optical contrast of 22.3 percent detected for the recording medium without the correction layer. The reflection index is equal to 0.06 (or 6 percent) for a correction layer thickness of 66 nm. This falls within the reflection range specified by the BD disc standard.

1. Optical storage medium comprising a storage layer (4) and a first layer (5), said first layer (5) providing optical properties sufficient for data retrieval from the storage layer (4) using a laser with a first wavelength W₁, characterized by a second layer providing optical properties sufficient for data retrieval from the storage layer (4) using a laser with a second wavelength W₂.

2. Optical storage medium according to claim 1, wherein the refraction index n_{L1}(W1) of the first layer for the first wavelength and the refraction index n_{L2}(W₁) of the second layer for the first wavelength are chosen in such a way, that the relative difference between the refraction indexes [n_{L1}(W1)−n_{L2}(W1)]/n_{L1}(W1) does not exceed 0.1.

3. Optical storage medium according to claim 1, wherein the second layer is made of 2-Ethylhexyl-2-cyano-4-(3- methyl-2-oxazolinylidene)-crotonate (C₁₇H₂₆N₂O₃).

4. Optical storage medium according to claim 1, wherein the first wavelength is within the range of 650 to 670 nm and the second wavelength is 405 nm.

5. Optical storage medium according to claim 1, wherein the second layer has a thickness within the range of 60 to 70 nm.
